(19) United States
(12) Patent Application Publication
(10) Pub. No.: US 2024/0375220 A1
(43) Pub. Date: Nov. 14, 2024

(54) LASER MACHINING METHOD AND LASER MACHINING APPARATUS

(71) Applicant: HONDA MOTOR CO., LTD., Tokyo (JP)

(72) Inventors: Yasuhiro Ito, Tokyo (JP); Keisuke Takahashi, Tokyo (JP); Naoharu Wakida, Tokyo (JP); Tsunenari Futagi, Tokyo (JP); Ayanori Nagata, Tokyo (JP); Toshiki Iida, Tokyo (JP); Hideaki Imanishi, Tokyo (JP)

(21) Appl. No.: 18/652,817

(22) Filed: May 2, 2024

(30) Foreign Application Priority Data
May 10, 2023 (JP) 2023-077900

(51) Int. Cl. B23K 26/352

(52) U.S. Cl. CPC B23K 26/352

(57) ABSTRACT

A laser machining apparatus includes a laser device, an image processing part, and an irradiation controller. The laser device irradiates a surface of a machining object with a laser beam. The image processing part divides an image for drawing with respect to the surface of the machining object into a plurality of gradations and creates a plurality of layer according to the plurality of gradations. The irradiation controller draws a layer on the surface of the machining object by scanning and linearly irradiating each of the plurality of layer with a laser beam in a single direction.

### CROSS-REFERENCE TO RELATED APPLICATION

Priority is claimed on Japanese Patent Application No. 2023-077900, filed May 10, 2023, the content of which is incorporated herein by reference.

### BACKGROUND OF THE INVENTION

### Field of the Invention

The present invention relates to a laser machining method and a laser machining apparatus.

### Description of Related Art

In the related art, when a circuit pattern is drawn on a substrate surface by irradiation of a laser beam, there is known a drawing device configured to set a gradation of a quantity of light equivalent to the number of overlapping times by overlapping and exposing the laser beams on the entire surface of a pattern projection region a plurality of times (for example, see Japanese Unexamined Patent Application, First Publication No. 2004-354415).

### SUMMARY OF THE INVENTION

Incidentally, in the drawing device using the laser beam, for example, drawing by stippling can be performed by setting light and shade for each dot according to conditions such as an output, a speed, a frequency, a condensing diameter, and the like of the laser. However, in the case of the stippling, it is not possible to perform drawing between the adjacent dots, which limits expression such as depth feeling or the like.

For example, in the drawing device in the related art, although the dot size can be made uniform by setting the light and shade by overlapping the patterns, there is a problem that the drawing is not performed between the adjacent dots and the expression is restricted.

An aspect of the present invention is directed to providing a laser machining method and a laser machining apparatus that are capable of suppressing limitation of drawing expression.

The present invention employs the following aspects.

(1) A laser machining method according to an aspect of the present invention is a laser machining method of executing image drawing by irradiating a surface of a machining object with a laser beam using electronic equipment (for example, a processing apparatus (13) according to an embodiment), the laser machining method including causing the electronic equipment to perform: a dividing process (for example, step S04 according to the embodiment) of dividing the image by a plurality of gradations (for example, each of gradations (T1, T2, T3, T4, T5, T6, T7 and T8) according to the embodiment); a creating process (for example, step S05 according to the embodiment) of creating a plurality of layers (for example, each of layers (L1, L2, L3, L4, L5, L6 and L7) according to the embodiment) according to the plurality of gradations; and a machining process (for example, step S13 according to the embodiment) of scanning the laser beam and irradiating the laser beam linearly to each of the plurality of layers in a single direction.

(2) In the laser machining method according to the aspect of the above-mentioned (1), any one of the plurality of gradations may be a color of a surface of the machining object, and the plurality of layers created in the creating process may be layers corresponding to the plurality of gradations other than the gradation which is the color of the surface of the machining object.

(3) In the laser machining method according to the aspect of the above-mentioned (1) or (2), the single direction, which is a scanning direction of the laser beam in the machining process, may differ for each of the plurality of layers.

(4) In the laser machining method according to the aspect of the above-mentioned (3), the scanning direction may be rotated by a predetermined angle for each of the plurality of layers in sequence.

(5) In the laser machining method according to the aspect of the above-mentioned (4), the predetermined angle may be an angle obtained by dividing 180 degrees by the number of the gradations.

(6) In the laser machining method according to the aspect of the above-mentioned (1) or (2), the electronic equipment may perform: an acquisition process (for example, step S02 according to the embodiment) of acquiring a histogram showing a frequency distribution of a pixel value on the image; and an extraction process (for example, step S03 according to the embodiment) of extracting a peak from the histogram, and the plurality of gradations may be set in the dividing process using the peak as a boundary.

(7) In the laser machining method according to the aspect of the above-mentioned (6), the peak in the extraction process may be greater than a lower limit threshold set by the histogram.

(8) A laser machining apparatus (for example, a laser machining apparatus (10) according to the embodiment) according to an aspect of the present invention includes a laser device (for example, a laser device (11) according to the embodiment) configured to irradiate a surface of a machining object with a laser beam; an image processing part (for example, an image processing part (21) according to the embodiment) configured to divide an image into a plurality of gradations (for example, each of gradations (T1, T2, T3, T4, T5, T6, T7 and T8) according to the embodiment) and create a plurality of layers (for example, each of layers (L1, L2, L3, L4, L5, L6 and L7) according to the embodiment) according to the plurality of gradations; and an irradiation controller (for example, an irradiation controller (23) according to the embodiment) configured to draw the layer on a surface of the machining object by scanning and irradiating linearly the laser beam to each of the plurality of layers in a single direction.

According to the aspect of the above-mentioned (1), by scanning and linearly irradiating each layer with a laser beam in a single direction, for example, compared to the case of stippling with irradiation for each dot, seamless drawing can be performed. Drawing of each layer can be performed by linearly scanning the laser beam in the single direction while switching irradiation of the laser beam on and off, and for example, compared to the case of stippling with irradiation for each dot, it is possible to suppress an increase in data required for irradiation control.

In the case of the aspect of the above-mentioned (2), since the layer with respect to the gradation corresponding to the color of the surface of the machining object is not created, for example, compared to the case in which the layer corresponding to all the gradations is created, it is possible to suppress an increase in data required for irradiation control while maintaining accurate drawing.

In the case of the aspect of the above-mentioned (3), since the scanning directions of the plurality of layers are different from each other, for example, compared to the case in which the same scanning direction is set for the different layers, it is possible to suppress the boundary of linear drawing from becoming clear and perform seamless drawing.

In the case of the aspect of the above-mentioned (4), since the scanning direction is rotated by a predetermined angle for each of the plurality of layers in sequence, even more seamless drawing can be performed and irradiation control can be prevented from becoming complicated.

In the case of the aspect of the above-mentioned (5), the predetermined angle is an angle obtained by dividing 180 degrees by the number of gradations, so it is possible to maximize the smoothness of drawing when rotating the scanning direction according to the number of layers.

In the case of the aspect of the above-mentioned (6), since the gradation is divided by the peak of the histogram, clear drawing can be performed.

In the case of the aspect of the above-mentioned (7), by setting the lower limit threshold in the histogram, it is possible to suppress an increase in data required for irradiation control while maintaining clear drawing.

According to the aspect of the above-mentioned (8), by scanning the laser beam in the single direction in each layer and performing linear irradiation, for example, seamless drawing can be performed compared to the case of stippling with irradiation for each dot. Drawing of each layer can be performed by linearly scanning the laser beam in the single direction while switching irradiation of the laser beam on and off, and for example, compared to the case of stippling with irradiation for each dot, it is possible to suppress an increase in data required for irradiation control.

### BRIEF DESCRIPTION OF THE DRAWINGS

FIG. 1 is a block diagram showing a functional configuration of a laser machining apparatus of an embodiment of the present invention.

FIG. 2 is a flowchart showing an operation of an image processing part in the laser machining apparatus of the embodiment of the present invention.

FIG. 3 is a flowchart showing an operation of an irradiation controller in the laser machining apparatus of the embodiment of the present invention.

FIG. 4 is a view showing an example of a histogram showing a frequency distribution of a pixel value in a gray scale image, an extracted peak and a set gradation acquired by the laser machining apparatus of the embodiment of the present invention.

FIG. 5 is a view showing an example of drawing of a plurality of layers acquired by the laser machining apparatus of the embodiment of the present invention.

### DETAILED DESCRIPTION OF THE INVENTION

Hereinafter, a laser machining apparatus according to an embodiment of the present invention will be described with reference to the accompanying drawings.

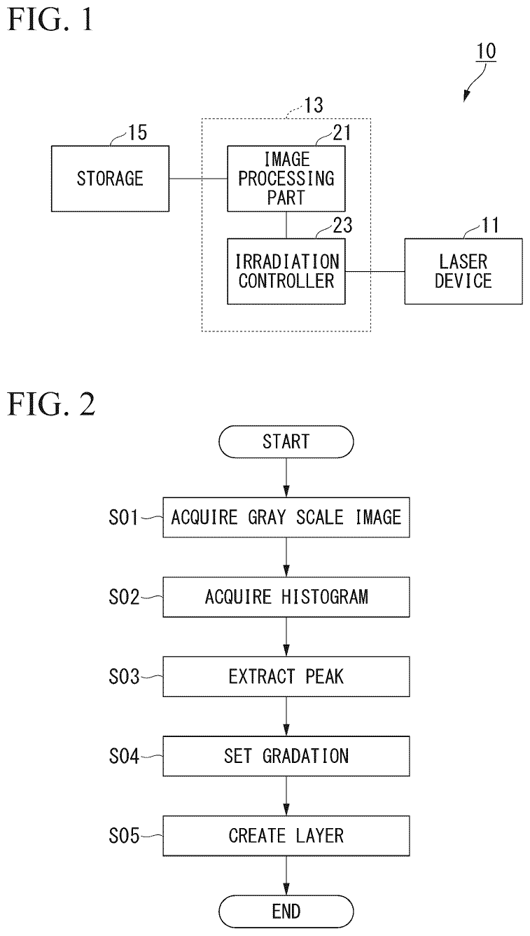

FIG. 1 is a block diagram showing a functional configuration of a laser machining apparatus 10 according to the embodiment.

As shown in FIG. 1, the laser machining apparatus 10 includes for example, a laser device 11, a processing apparatus 13, and a storage 15.

The laser device 11 includes, for example, a laser oscillator, an optical system, a driving stage, and the like.

The laser oscillator oscillates various types of laser beams. The optical system transmits and condenses a laser beam generated from the laser oscillator and radiates the laser beam to a machining object. The driving stage fixes the machining object, and for example, sets a position and a posture of the machining object through translation in each axial direction in a three-dimensional orthogonal coordinate system and rotation around each of predetermined rotation and tilt axes.

The processing apparatus 13 is, for example, a software function part that functions by executing a predetermined program using a processor such as a central processing unit (CPU) or the like. The software function part is an ECU including a processor such as a CPU or the like, a read only memory (ROM) configured to store a program, a random access memory (RAM) configured to store data temporarily, and an electronic circuit such as a timer or the like. Further, at least a part of the processing apparatus 13 may be an integrated circuit such as a large scale integration (LSI) or the like.

The processing apparatus 13 includes, for example, an image processing part 21, and an irradiation controller 23.

The image processing part 21 processes an image drawn on a surface of the machining object. For example, the image processing part 21 acquires a gray scale image on the basis of the image stored in the storage 15. The image processing part 21 acquires, for example, a gray scale image by reading a pre-created gray scale image from the storage 15 or by performing color reduction processing such as gradation or the like on a color image of the storage 15. The image processing part 21 acquires a histogram showing a frequency distribution of a pixel value (light and shade of color) in the gray scale image. The image processing part 21 divides the gray scale image into a plurality of gradations on the basis of a peak extracted from a range greater than a predetermined lower limit threshold in the histogram. The image processing part 21 configures the gray scale image on the basis of the plurality of layers by creating the plurality of layers according to the plurality of gradations. The image processing part 21 sets, for example, any one of the plurality of gradations as a color of the surface of the machining object. The image processing part 21 does not create a layer corresponding to the gradation that is the color of the surface of the machining object, but only creates a layer that corresponds to a gradation other than the gradation that is the color of the surface of the machining object.

The irradiation controller 23 controls an operation of the laser device 11. For example, the irradiation controller 23 irradiates the surface of the machining object with the laser beam according to each of the plurality of layers created by the image processing part 21. The irradiation controller 23 linearly radiates the laser beams while scanning the laser beams in the plurality of layers in different single directions, respectively. The irradiation controller 23 performs drawing according to each layer by switching between ON and OFF of irradiation upon scanning of the laser beam in the single direction. The irradiation controller 23 rotates, for example, the scanning direction of the laser beam in sequence of the plurality of layers by a predetermined angle θ. The predetermined angle θ is, for example, an angle obtained by dividing 180 degrees by the number of gradations.

The storage 15 stores an image drawn on the surface of the machining object.

Hereinafter, an operation example of the laser machining apparatus 10 according to the embodiment, i.e., the laser machining method will be described.

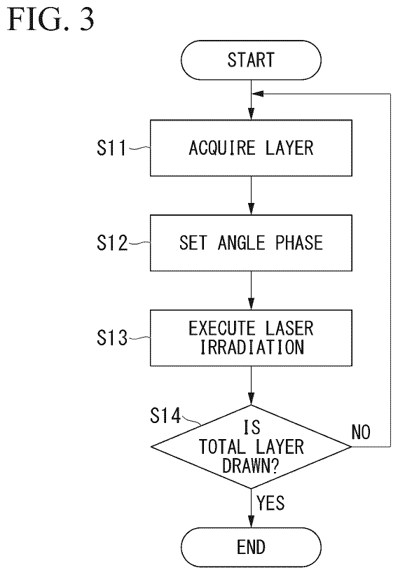

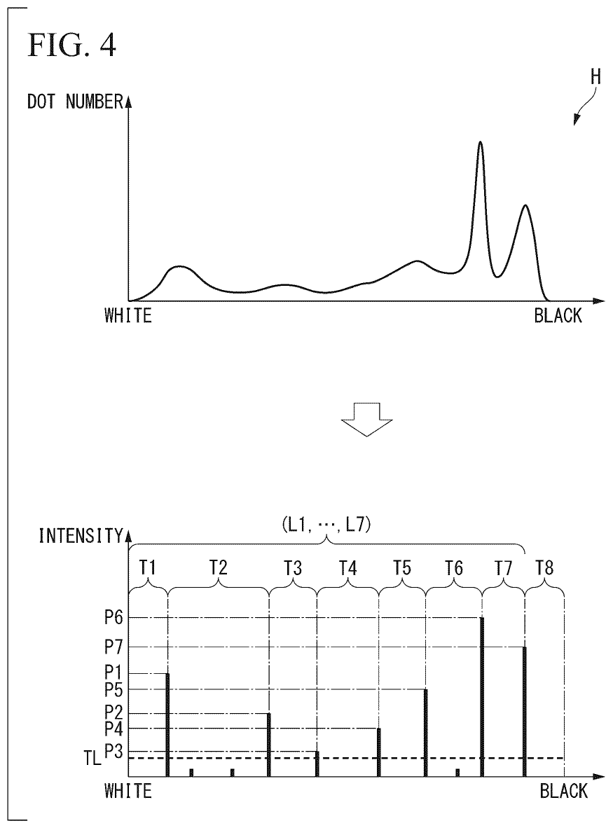

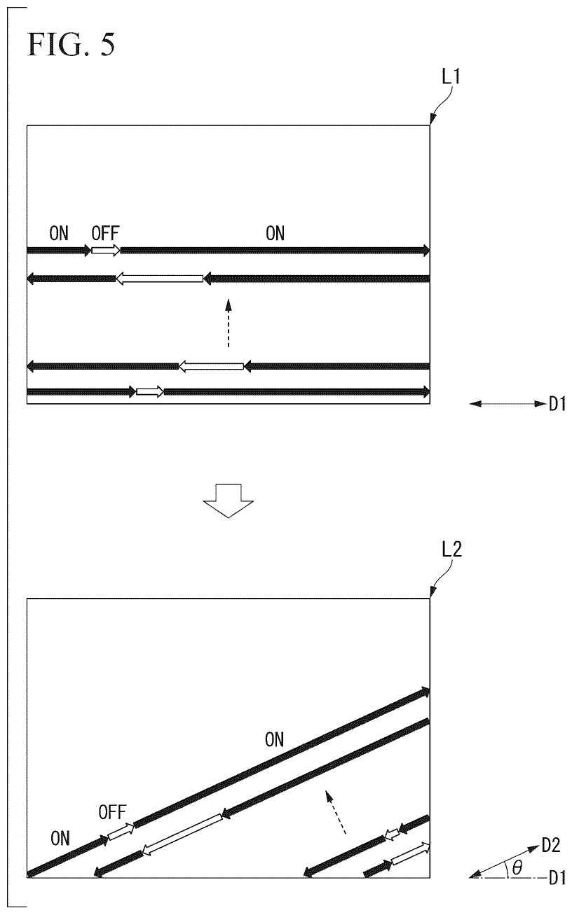

FIG. 2 is a flowchart showing an operation of the image processing part 21 in the laser machining apparatus 10 of the embodiment. FIG. 3 is a flowchart showing an operation of the irradiation controller 23 in the laser machining apparatus 10 of the embodiment. FIG. 4 is a view showing an example of a histogram showing a frequency distribution of pixel values in the gray scale image acquired by the laser machining apparatus 10 of the embodiment, the extracted peak and the set gradation. FIG. 5 is a view showing an example of a drawing of the plurality of layers acquired by the laser machining apparatus 10 of the embodiment.

As shown in FIG. 2, first, the image processing part 21 acquires a gray scale image for drawing with respect to the surface of the machining object on the basis of the image stored in the storage 15 (step S01).

Next, the image processing part 21 acquires a histogram showing a frequency distribution of a pixel value (light and shade of color) in the gray scale image (step S02). As shown in FIG. 4, a histogram H of the gray scale image shows the distribution of the number of dots according to each brightness from white color, which is the lightest color, to black color, which is the darkest color.

Next, the image processing part 21 extracts a peak of a number according to a default gradation number from a range greater than a predetermined lower limit threshold TL with respect to a dot number in the histogram H (step S03 shown in FIG. 2). A preset gradation number is, for example, 256 gradations corresponding to 8 bits, 16 gradations corresponding to 4 bits, 8 gradations corresponding to 2 bits, and the like. The peak number corresponding to the default gradation number is, for example, a number obtained by subtracting 1 from the gradation number (=gradation number−1).

Next, the image processing part 21 divides the pixel value (light and shade of color) of the gray scale image into a plurality of gradations on the basis of the peak extracted from the histogram (step S04 shown in FIG. 2). The image processing part 21 sets, for example, a plurality of gradations using a position of a peak value (maximum value) of each peak as a boundary. As shown in FIG. 4, for example, when seven peak values from a first peak value P1 to a seventh peak value P7 (each of the peak values P1, P2, P3, P4, P5, P6 and P7) are extracted in sequence from white color toward black color corresponding to 8 gradations of 2 bits, eight gradations from a first gradation T1 to an eighth gradation T8 (each of the gradations T1, T2, T3, T4, T5, T6, T7 and T8) are set in sequence from white color toward black color.

Next, the image processing part 21 configures the gray scale image with the plurality of layers by creating the plurality of layers according to the plurality of gradations (step S05 shown in FIG. 2). Then, the image processing part 21 advances the processing to end. The image processing part 21 sets, for example, the eighth gradation T8 including the darkest black color among the eight gradations as the color of the surface of the machining object. The image processing part 21 does not create a layer corresponding to the eighth gradation T8 that is the color of the surface of the machining object, but only creates a layer corresponding to seven gradations from the first gradation T1 to the seventh gradation T7 other than the eighth gradation T8 (each of the gradations T1, T2, T3, T4, T5, T6 and T7). The image processing part 21 configures a new gray scale image again on the basis of the seven layers corresponding to the seven gradations (each of the layers L1, L2, L3, L4, L5, L6 and L7).

As shown in FIG. 3, first, the irradiation controller 23 acquires each of the plurality of layers created by the image processing part 21 in sequence (step S11).

Next, the irradiation controller 23 sets an angle phase of a laser beam with respect to each layer in a scanning direction (step S12). The angle phase is set by adding a predetermined angle to each of the plurality of layer in sequence. The predetermined angle is, for example, an angle obtained by dividing 180 degrees by the number of layers.

Next, the irradiation controller 23 scans the laser beam linearly in the scanning direction according to the angle phase set to each layer and irradiates the laser beam to the surface of the machining object (step S13). The irradiation controller 23 performs the drawing according to each layer by switching between ON and OFF of irradiation upon scanning of the laser beam of each layer in the single scanning direction.

As shown in FIG. 5, for example, first, for the first layer L1 corresponding to the first gradation T1 including the lightest white color among the eight gradations, the irradiation controller 23 sets a scanning direction (a first scanning direction D1) to a reference direction by setting the angle phase to “zero.” The reference direction is, for example, a lateral direction of the gray scale image or the like. The irradiation controller 23 irradiates a laser beam to the entire region of the first layer L1 by linearly scanning the laser beam in the first scanning direction D1 while switching between ON and OFF of irradiation according to the first layer L1 and moving the laser beam in sequence in a direction perpendicular to the first scanning direction D1 at a boundary position of the first layer L1 or the like.

Next, for the second layer L2 corresponding to the second gradation T2 adjacent to the first gradation T1, the irradiation controller 23 sets a scanning direction (a second scanning direction D2) to a direction rotated by the predetermined angle θ from the first scanning direction D1 by increasing the angle phase by the predetermined angle θ. The irradiation controller 23 irradiates a laser beam to the entire region of the second layer L2 by linearly scanning the laser beam in the second scanning direction D2 while switching between ON and OFF of irradiation according to the second layer L2 and moving the laser beam in sequence in a direction perpendicular to the second scanning direction D2 at a boundary position of the second layer L2 or the like.

Hereinafter, for other layers, the angle phase is sequentially increased by the predetermined angle θ, and laser beam irradiation is performed according to each layer.

Next, the irradiation controller 23 determines whether drawing of all layers is terminated (step S14).

When the determination result is “NO,” the irradiation controller 23 returns the processing to step S11.

Meanwhile, when the determination result is “YES,” the irradiation controller 23 advances the processing to the end.

As described above, according to the laser machining apparatus 10 and the laser machining method of the embodiment, by scanning the laser beam in the single direction in each layer and performing linear irradiation, for example, seamless drawing can be performed compared to the case of stippling with irradiation for each dot. The drawing of each layer can be performed by linearly scanning the laser beam in the single direction while switching between ON and OFF of irradiation of the laser beam, and for example, it is possible to suppress an increase in data required for irradiation control compared to the case of stippling with irradiation for each dot.

By performing linear irradiation for each of the plurality of layers according to the plurality of gradations, for example, it is possible to realize light and shade expression with depth feeling.

Since the layer is not created for the gradation that corresponds to the surface color of the machining object, for example, compared to the case in which the layer that corresponds to all gradations is created, it is possible to suppress an increase in data required for irradiation control while maintaining appropriate drawing.

Since the scanning directions of the plurality of layers are different from each other, for example, compared to the case in which the same scanning direction is set for the different layers, it is possible to suppress the boundary of linear drawing from becoming clear and perform seamless drawings.

Since the scanning direction is rotated by the predetermined angle θ for each of the plurality of layers in sequence, furthermore, seamless drawing can be performed and irradiation control can be prevented from becoming complicated.

The predetermined angle θ is the angle obtained by dividing 180 degrees by the number of gradations, so it is possible to maximize the smoothness of drawing when rotating the scanning direction according to the number of layers.

Since the gradation is divided according to the peak of the histogram, clear drawings can be performed. By setting the lower limit threshold TL in the histogram H, it is possible to suppress an increase in data required for irradiation control while maintaining clear drawing.

### (Variant)

Hereinafter, a variant of the embodiment will be described. Further, the same portions as in the above-mentioned embodiment are designated by the same reference signs and description thereof will be omitted or simplified.

In the above-mentioned embodiment, while the plurality of gradations are set using the position of the peak value (maximum value) of each peak extracted by the histogram as a boundary, there is no limitation thereto. For example, the plurality of gradations may be set on the basis of the parameter other than the peak value related to each peak such as a boundary between the neighboring peaks or the like.

In the above-mentioned embodiment, while it is assumed that the angle phase in the scanning direction changes by the predetermined angle θ in the order of the plurality of layers that are sequentially set according to the pixel value such as light and shade of colors going from white to black, there is no limitation thereto. For example, the angle phase in the scanning direction may be changed by the predetermined angle θ in the order of the plurality of layers depending on other parameters such as the peak value extracted by the histogram or the size of the peak area.

In the above-mentioned embodiment, while the scanning direction of the laser beam is sequentially rotated by the predetermined angle θ for each of the plurality of layers, there is no limitation thereto. For example, the scanning direction may be rotated by an angle set for each layer with weighting according to various parameters such as the peak value extracted by the histogram or the size of the peak area.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A laser machining method of executing image drawing by irradiating a surface of a machining object with a laser beam using electronic equipment,
the laser machining method including causing the electronic equipment to perform:
a dividing process of dividing the image by a plurality of gradations;
a creating process of creating a plurality of layers according to the plurality of gradations; and
a machining process of scanning the laser beam and irradiating the laser beam linearly to each of the plurality of layers in a single direction.

2. The laser machining method according to claim 1, wherein any one of the plurality of gradations is a color of a surface of the machining object, and
the plurality of layers created in the creating process are layers corresponding to the plurality of gradations other than the gradation which is the color of the surface of the machining object.

3. The laser machining method according to claim 1, wherein the single direction, which is a scanning direction of the laser beam in the machining process, differs for each of the plurality of layers.

4. The laser machining method according to claim 3, wherein the scanning direction is rotated by a predetermined angle for each of the plurality of layers in sequence.

5. The laser machining method according to claim 4, wherein the predetermined angle is an angle obtained by dividing 180 degrees by the number of the gradations.

6. The laser machining method according to claim 1, wherein the electronic equipment performs:
an acquisition process of acquiring a histogram showing a frequency distribution of a pixel value on the image; and
an extraction process of extracting a peak from the histogram, and
the plurality of gradations are set in the dividing process using the peak as a boundary.

7. The laser machining method according to claim 6, wherein the peak in the extraction process is greater than a lower limit threshold set by the histogram.

8. A laser machining apparatus comprising:
a laser device configured to irradiate a surface of a machining object with a laser beam;
an image processing part configured to divide an image into a plurality of gradations and create a plurality of layers according to the plurality of gradations; and
an irradiation controller configured to draw the layer on a surface of the machining object by scanning and linearly irradiating the laser beam to each of the plurality of layers in a single direction.
